(19) United States
(12) Patent Application Publication
(10) Pub. No.: US 2026/0088738 A1
(43) Pub. Date: Mar. 26, 2026

(54) ELECTRIC VEHICLE

(71) Applicant: HONDA MOTOR CO., LTD., Tokyo (JP)

(72) Inventor: Takuya INAZUMI, Tokyo (JP)

(73) Assignee: HONDA MOTOR CO., LTD., Tokyo (JP)

(21) Appl. No.: 19/331,458

(22) Filed: Sep. 17, 2025

(30) Foreign Application Priority Data
Sep. 23, 2024 (CN) 202411324615.X

(51) Int. Cl. H02P 5/74; B60L 15/04; B60L 15/20; H02P 4/00

(52) U.S. Cl. CPC H02P 5/74; B60L 15/04; B60L 15/20; H02P 4/00

(57) ABSTRACT

An electric vehicle including: a first traveling motor and a second traveling motor; a drive circuit configured to drive the first traveling motor and the second traveling motor; and a DC power supply device configured to output a first voltage and a second voltage lower than the first voltage, in which when supplied with the electric power of the first voltage, the drive circuit drives the first traveling motor and the second traveling motor with the electric power of the first voltage, and when supplied with the electric power of the second voltage, the drive circuit boosts the electric power of the second voltage using a coil of the first traveling motor to drive the second traveling motor with the boosted electric power.

### CROSS-REFERENCE TO RELATED APPLICATIONS

This application is based on and claims priority under 35 USC 119 from Chinese Patent Application No. 202411324615.X filed on Sep. 23, 2024, the entire content of which is incorporated herein by reference.

### TECHNICAL FIELD

The present disclosure relates to an electric vehicle.

### BACKGROUND ART

An electric vehicle that drives drive wheels of the vehicle by power of a traveling motor generally includes, as a power supply, a high voltage battery that stores electric power supplied to the traveling motor and a low voltage battery. The electric power stored in the low voltage battery is supplied to, for example, various in-vehicle auxiliary machines.

If an abnormality occurs in the high voltage battery, the electric power may not be appropriately supplied from the high voltage battery to the traveling motor, which disables traveling of the electric vehicle. Practical use has progressed in autonomous driving systems having a driving automation level of 4 or higher, that is, an autonomous driving system that executes the entire driving of a vehicle under a specific condition or unconditionally. In such a system, the driver is expected to be absent, which requires redundancy for the abnormality of the high voltage battery.

If an abnormality occurs in the high voltage battery, a drive device described in JP2017-112809A and a power supply system described in JP2020-156270A boost electric power stored in the low voltage battery and supply the boosted electric power to the traveling motor to continue the traveling of the electric vehicle. Accordingly, for example, the vehicle can be evacuated to a safe place.

The drive device described in JP2017-112809A and the power supply system described in JP2020-156270A require a booster device for boosting the electric power stored in the low voltage battery, which may increase the cost and the weight.

An object of the present disclosure is to provide an electric vehicle capable of continuing traveling regardless of a decrease in power supply voltage.

### SUMMARY OF INVENTION

According to an aspect of the present disclosure, there is provided an electric vehicle including:

a first traveling motor and a second traveling motor;

a drive circuit configured to drive the first traveling motor and the second traveling motor; and

a DC power supply device configured to supply electric power to the drive circuit, in which

the power supply device is configured to output a first voltage and a second voltage lower than the first voltage,

when supplied with the electric power of the first voltage, the drive circuit drives the first traveling motor and the second traveling motor with the electric power of the first voltage, and

when supplied with the electric power of the second voltage, the drive circuit boosts the electric power of the second voltage using a coil of the first traveling motor to drive the second traveling motor with the boosted electric power.

### BRIEF DESCRIPTION OF DRAWINGS

FIG. 1 is a block diagram of an electric vehicle according to an embodiment of the present disclosure.

FIG. 2 is a circuit diagram of a drive circuit of the electric vehicle.

FIG. 3 is a circuit diagram of a drive circuit having a first drive configuration.

FIG. 4 is a circuit diagram of a drive circuit having a second drive configuration.

FIG. 5 is a circuit diagram of the drive circuit having the second drive configuration.

FIG. 6 is a circuit diagram of the drive circuit having the second drive configuration.

FIG. 7 is a block diagram of a modification of the electric vehicle.

FIG. 8 is a block diagram of a power supply device of the electric vehicle.

FIG. 9 is a circuit diagram of an output circuit having a first output configuration.

FIG. 10 is a circuit diagram of an output circuit having a second output configuration.

FIG. 11 is a circuit diagram of the output circuit having the second output configuration.

FIG. 12 is a block diagram of a modification of the power supply device.

### DESCRIPTION OF EMBODIMENTS

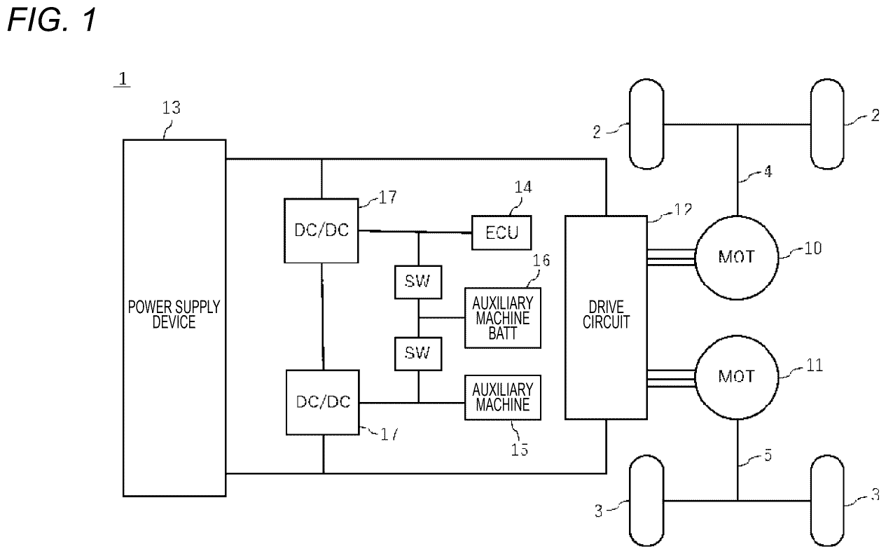

FIG. 1 illustrates an example of an electric vehicle.

An electric vehicle 1 illustrated in FIG. 1 is a four-wheeled automobile including a pair of left and right front wheels and a pair of left and right rear wheels. The electric vehicle 1 includes a first traveling motor 10, a second traveling motor 11, a drive circuit 12 for driving the first traveling motor 10 and the second traveling motor 11, and a DC power supply device 13 capable of supplying electric power to the drive circuit 12.

The power output from the first traveling motor 10 is transmitted to one wheel 2 among the front wheels and the rear wheels. The power output from the second traveling motor 11 is transmitted to another wheel 3 among the front wheels and the rear wheels. Although not illustrated, a power transmission path 4 between the first traveling motor 10 and the wheel 2 and a power transmission path 5 between the second traveling motor 11 and the wheel 3 are each provided with a differential device. A speed reducer may be provided between the first traveling motor 10 and the differential device and between the second traveling motor 11 and the differential device.

The electric vehicle 1 further includes an electronic control unit (ECU) 14, another auxiliary machine 15 (lights, navigation system, or the like), and an auxiliary machine battery 16 capable of supplying electric power to the ECU 14 and the auxiliary machine 15. The ECU 14 is mainly configured with a processor, and controls the operation of the units of the electric vehicle 1 including the drive circuit 12 and the power supply device 13.

The power supply device 13 includes a main battery and outputs a high voltage required to drive the first traveling motor 10 and the second traveling motor 11. The auxiliary machine battery 16 outputs a low voltage required for the operations of the ECU 14 and the auxiliary machine 15. The auxiliary machine battery 16 is charged with electric power supplied from the power supply device 13. A DC-DC converter 17 for converting a high voltage output of the power supply device 13 into a low voltage is provided between the power supply device 13 and the auxiliary machine battery 16.

The power supply device 13 can output a first voltage (e.g., 800 volts) and a second voltage (e.g., 400 volts) lower than the first voltage. In a normal state, the power supply device 13 outputs the first voltage. On the other hand, if an abnormality occurs in a part of the main battery of the power supply device 13, or if the state of charge (SOC) of the main battery is lowered, the power supply device 13 outputs the second voltage. An abnormality of the main battery and a decrease in the SOC are detected by a sensor. If an abnormality of the main battery or a decrease in the SOC is detected, the ECU 14 controls the power supply device 13 to output the second voltage.

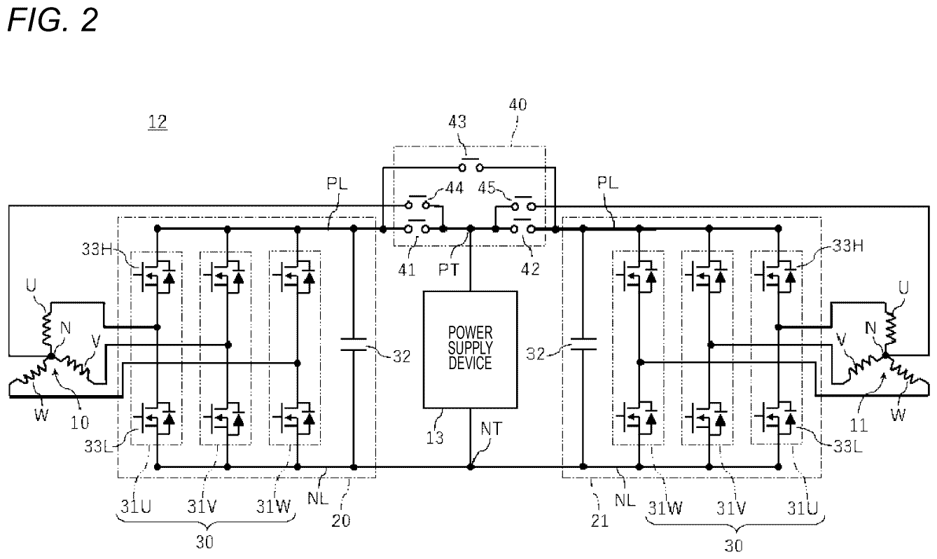

FIG. 2 illustrates the drive circuit 12.

If supplied with the electric power of the first voltage from the power supply device 13, the drive circuit 12 drives the first traveling motor 10 and the second traveling motor 11 with the electric power of the first voltage. If supplied with the electric power of the second voltage from the power supply device 13, the drive circuit 12 boosts the electric power of the second voltage using a coil of the first traveling motor 10. The drive circuit 12 drives the second traveling motor 11 with the boosted electric power.

In the example illustrated in FIG. 2, the first traveling motor 10 is a three-phase AC motor, and the coil of the first traveling motor 10 includes a U-phase winding U, a V-phase winding V, and a W-phase winding W. The drive circuit 12 includes a first drive circuit 20 for driving the first traveling motor 10. The first drive circuit 20 includes an inverter 30. The inverter 30 generates a three-phase AC current having phases different from each other by 120°. The U-phase winding U, the V-phase winding V, and the W-phase winding W of the first traveling motor 10 are excited to form a rotating magnetic field by the three-phase AC current generated by the inverter 30. A rotor of the first traveling motor 10 rotates in accordance with the rotation of the magnetic field, so that the first traveling motor 10 generates power.

The inverter 30 includes switch circuits 31U, 31V, and 31W for three phases. One end of each of the switch circuits 31U, 31V, and 31W is connected to a positive-side input line PL of the first drive circuit 20, and the other end of each of the switch circuits 31U, 31V, and 31W is connected to a negative-side input line NL of the first drive circuit 20. The first drive circuit 20 includes a capacitor 32 for stabilizing the line-to-line voltage between the positive-side input line PL and the negative-side input line NL. One end of the capacitor 32 is connected to the positive-side input line PL, and the other end of the capacitor 32 is connected to the negative-side input line NL.

The switch circuit 31U includes a high-side switch 33H and a low-side switch 33L. The high-side switch 33H and the low-side switch 33L are connected in series. Similarly, the switch circuits 31V and 31W also include a high-side switch 33H and a low-side switch 33L. The high-side switch 33H and the low-side switch 33L are configured with semiconductor switching elements such as insulated gate bipolar transistor (IGBT) and metal oxide semiconductor field effect transistor (MOSFET), and is controlled to turn on/off by the ECU 14.

One end of the U-phase winding U of the first traveling motor 10 is connected to the switch circuit 31U between the high-side switch 33H and the low-side switch 33L of the switch circuit 31U. One end of the V-phase winding V is connected to the switch circuit 31V between the high-side switch 33H and the low-side switch 33L of the switch circuit 31V. One end of the W-phase winding W is connected to the switch circuit 31W between the high-side switch 33H and the low-side switch 33L of the switch circuit 31W. By periodically turning on/off the high-side switch 33H and the low-side switch 33L of each of the switch circuits 31U, 31V, and 31W, a three-phase AC current is generated and supplied to the U-phase winding U, the V-phase winding V, and the W-phase winding W of the first traveling motor 10.

The second traveling motor 11 is also a three-phase AC motor, and the coil of the second traveling motor includes a U-phase winding U, a V-phase winding V, and a W-phase winding W. The drive circuit 12 includes a second drive circuit 21 for driving the second traveling motor 11. The second drive circuit 21 is configured similarly to the first drive circuit 20.

The first traveling motor 10 and the second traveling motor 11 are not limited to three-phase AC motors, and may be multi-phase AC motors having four or more phases. The inverters 30 of the first drive circuit 20 and the second drive circuit 21 are appropriately configured in accordance with the number of phases of the first traveling motor 10 and the second traveling motor 11.

If the electric power of the first voltage is supplied from the power supply device 13 to the drive circuit 12, the first drive circuit 20 and the second drive circuit 21 are connected to the power supply device 13 in parallel. The first drive circuit 20 and the second drive circuit 21 respectively generate three-phase AC currents based on the electric power supplied from the power supply device 13 to drive the first traveling motor 10 and the second traveling motor 11.

On the other hand, if the electric power of the second voltage is supplied from the power supply device 13 to the drive circuit 12, direct supply of electric power from the power supply device 13 to the second drive circuit 21 is cut off. The U-phase winding U, the V-phase winding V, and the W-phase winding W of the first traveling motor 10 and the switch circuits 31U, 31V, and 31W included in the inverter 30 of the first drive circuit 20 form a booster circuit. The electric power of the second voltage is supplied from the power supply device 13 to the booster circuit, and the electric power boosted by the booster circuit is supplied to the second drive circuit 21. The second drive circuit 21 generates a three-phase AC current based on the boosted electric power to drive the second traveling motor 11.

Since the first traveling motor 10 and the first drive circuit 20 have the same configuration as the second traveling motor 11 and the second drive circuit 21 as described above, the U-phase winding U, the V-phase winding V, and the W-phase winding W of the second traveling motor 11 and the switch circuits 31U, 31V, and 31W included in the inverter 30 of the second drive circuit 21 may form a booster circuit. In this case, direct supply of the electric power from the power supply device 13 to the first drive circuit 20 is cut off, and a booster circuit is formed between the power supply device 13 and the first drive circuit 20. The first drive circuit 20 generates a three-phase AC current based on the boosted electric power to drive the first traveling motor 10.

The drive circuit 12 further includes a drive circuit switching unit 40. The drive circuit switching unit 40 switches the configuration of the drive circuit 12 between a first drive configuration, in which the first drive circuit 20 and the second drive circuit 21 are connected to the power supply device 13 in parallel, and a second drive configuration, in which direct supply of the electric power from the power supply device 13 to the first drive circuit 20 or the second drive circuit 21 is cut off and a booster circuit is formed between the power supply device 13 and the first drive circuit 20 or the second drive circuit 21.

The drive circuit switching unit 40 includes switches 41 to 45. The switch 41 connects the positive-side input line PL of the first drive circuit 20 and a positive electrode terminal PT of the power supply device 13. The switch 42 connects a positive-side input line PL of the second drive circuit 21 and the positive electrode terminal PT of the power supply device 13. The switch 43 connects the positive-side input line PL of the first drive circuit 20 and the positive-side input line PL of the second drive circuit 21. The switch 44 connects a neutral point N, where the U-phase winding U, the V-phase winding V, and the W-phase winding W of the first traveling motor 10 are combined, to the positive electrode terminal PT of the power supply device 13. The switch 45 connects the neutral point N, where the U-phase winding U, the V-phase winding V, and the W-phase winding W of the second traveling motor 11 are combined, to the positive electrode terminal PT of the power supply device 13. The switches 41 to 45 are configured with semiconductor switching elements such as IGBT or MOSFET, or a mechanical switch such as relay. The switches 41 to 45 are controlled to turn on/off by the ECU 14.

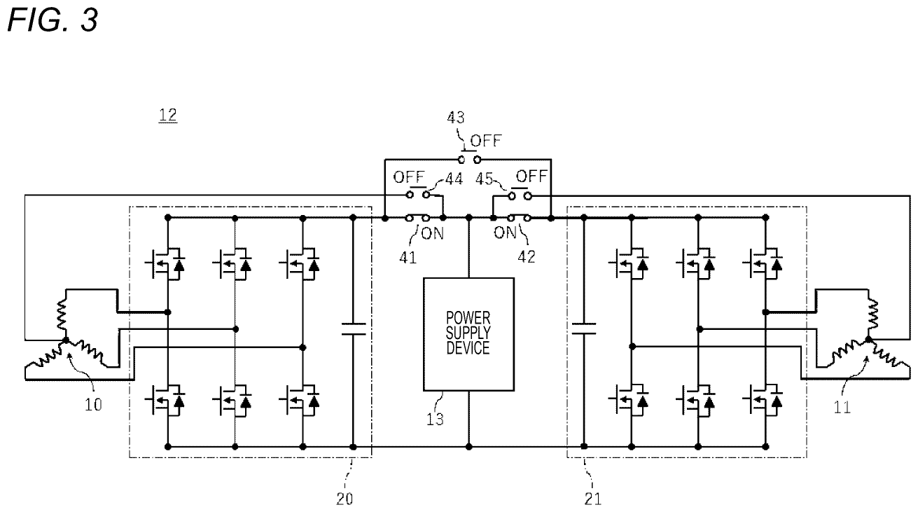

FIG. 3 illustrates the drive circuit 12 of the first drive configuration.

In the first drive configuration, the switch 41 and the switch 42 are turned on, and the switch 43-45 is turned off. The first drive circuit 20 and the second drive circuit 21 are connected to the power supply device 13 in parallel. The first drive circuit 20 and the second drive circuit 21 respectively generate three-phase AC currents based on the electric power of the first voltage supplied from the power supply device 13 to drive the first traveling motor 10 and the second traveling motor 11.

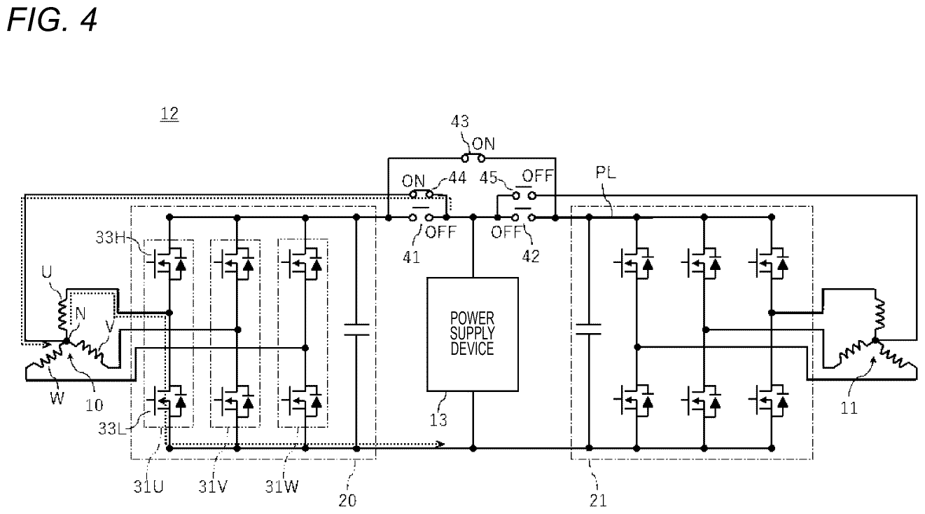

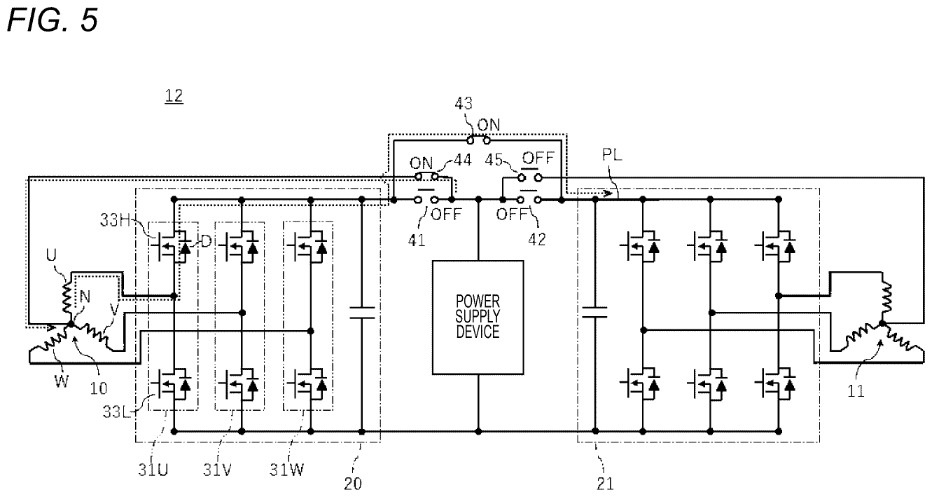

FIGS. 4 and 5 illustrate the drive circuit 12 of the second drive configuration.

In the second drive configuration, the switch 43 and switch 44 are turned on, and the switch 41, switch 42, and switch 45 are turned off. By turning off the switch 41 and the switch 42, the positive-side input line PL of each of the first drive circuit 20 and the second drive circuit 21 is disconnected from the positive electrode terminal PT of the power supply device 13. The respective positive-side input lines PL of the first drive circuit 20 and the second drive circuit 21 are connected in series via the switch 43 in the ON state. Further, the neutral point N of the first traveling motor 10 is connected to the positive electrode terminal PT of the power supply device 13 via the switch 44 in the ON state. The booster circuit formed by the U-phase winding U, the V-phase winding V, and the W-phase winding W of the first traveling motor 10 and the switch circuits 31U, 31V, and 31W of the first drive circuit 20 in the second drive configuration will be described below.

First, the high-side switch 33H of the switch circuit 31U is turned off, and the low-side switch 33L is turned on. As indicated by a dashed arrow in FIG. 4, a current flows from the power supply device 13 to the U-phase winding U through the switch 44 and the low-side switch 33L of the switch circuit 31U, which are in the ON state, and energy is stored in the U-phase winding U.

Next, the low-side switch 33L of the switch circuit 31U is turned off. By turning off the low-side switch 33L, the U-phase winding U releases the stored energy. As indicated by a dashed arrow in FIG. 5, a current flows from the power supply device 13 to the positive-side input line PL of the second drive circuit 21 through the switch 44 in the ON state, a freewheeling diode D of the high-side switch 33H of the switch circuit 31U, and the switch 43 in the ON state. The voltage induced in the U-phase winding U is superimposed on the second voltage output from the power supply device 13, and the boosted voltage is input to the second drive circuit 21. The V-phase winding V and the switch circuit 31V, and the W-phase winding W and the switch circuit 31W also perform the same boosting operation as the U-phase winding U and the switch circuit 31U. The second drive circuit 21 generates a three-phase AC current based on the boosted electric power to drive the second traveling motor 11.

The boosted voltage changes according to the time during which the low-side switches 33L of the switch circuits 31U, 31V, and 31W are on, and the boosted voltage increases as the time increases. By turning on/off the low-side switches 33L of the switch circuits 31U, 31V, and 31W in different phases, it is possible to prevent the pulsation of the boosted voltage input to the second drive circuit 21.

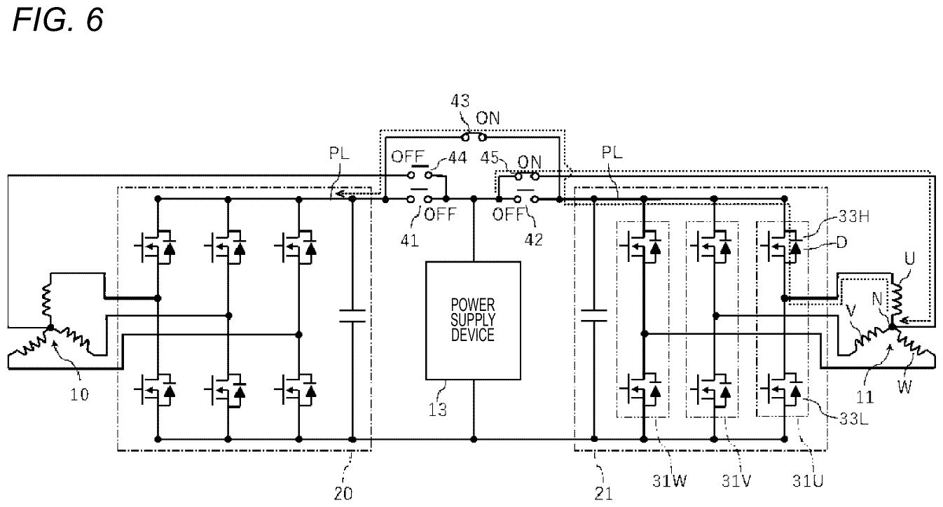

In the drive circuit 12 of the second drive configuration illustrated in FIGS. 4 and 5, the U-phase winding U, the V-phase winding V, and the W-phase winding W of the first traveling motor 10 and the switch circuits 31U, 31V, and 31W of the first drive circuit 20 form a booster circuit, but the U-phase winding U, the V-phase winding V, and the W-phase winding W of the second traveling motor 11 and the switch circuits 31U, 31V, and 31W of the second drive circuit 21 may form a booster circuit as illustrated in FIG. 6.

In the second drive configuration illustrated in FIG. 6, the switch 43 and switch 45 are turned on, and the switch 41, switch 42, and switch 44 are turned off. By turning off the switch 41 and the switch 42, the positive-side input line PL of each of the first drive circuit 20 and the second drive circuit 21 is disconnected from the positive electrode terminal PT of the power supply device 13. The respective positive-side input lines PL of the first drive circuit 20 and the second drive circuit 21 are connected in series via the switch 43 in the ON state. Further, the neutral point N of the second traveling motor 11 is connected to the positive electrode terminal PT of the power supply device 13 via the switch 45 in the ON state.

Focusing on the U-phase winding U of the second traveling motor 11 and the switch circuit 31U of the second drive circuit 21, first, the high-side switch 33H of the switch circuit 31U is turned off and the low-side switch 33L is turned on. A current flows from the power supply device 13 to the U-phase winding U through the switch 45 and the low-side switch 33L, which are in the ON state, and energy is stored in the U-phase winding U.

Next, the low-side switch 33L of the switch circuit 31U is turned off. By turning off the low-side switch 33L, the U-phase winding U releases the stored energy. As indicated by a dashed arrow in FIG. 6, a current flows from the power supply device 13 to the positive-side input line PL of the first drive circuit 20 through the switch 45 in the ON state, the freewheeling diode D of the high-side switch 33H, and the switch 43 in the ON state. The voltage induced in the U-phase winding U is superimposed on the second voltage output from the power supply device 13, and the boosted voltage is input to the first drive circuit 20. The first drive circuit 20 generates a three-phase AC current based on the boosted electric power to drive the first traveling motor 10.

Accordingly, even if the voltage output from the power supply device 13 decreases to the second voltage due to an abnormality of the main battery, a decrease in the SOC, or the like, the voltage required to drive the first traveling motor 10 can be secured, and the traveling of the electric vehicle 1 can be continued.

As described above, the electric vehicle 1 boosts the second voltage output from the power supply device 13 using the coil of one of the first traveling motor 10 and the second traveling motor 11 to drive the other of the first traveling motor 10 and the second traveling motor 11 with the boosted electric power. Even if the voltage output from the power supply device 13 decreases to the second voltage due to an abnormality of the main battery, a decrease in the SOC, or the like, the voltage required to drive the first traveling motor 10 or the second traveling motor 11 can be secured, and the traveling of the electric vehicle 1 can be continued. By boosting using the coil of one of the first traveling motor 10 and the second traveling motor 11, an increase in cost and weight can be prevented.

In particular, in the electric vehicle 1, the multi-phase windings U, V, and W forming the coil of the first traveling motor 10 and the high-side switch 33H and the low-side switch 33L as the semiconductor switching elements of the first drive circuit 20 can form a booster circuit, or the multi-phase windings U, V, and W forming the coil of the second traveling motor 11 and the high-side switch 33H and the low-side switch 33L as the semiconductor switching elements of the second drive circuit 21 can form a booster circuit, thereby further preventing an increase in cost and weight.

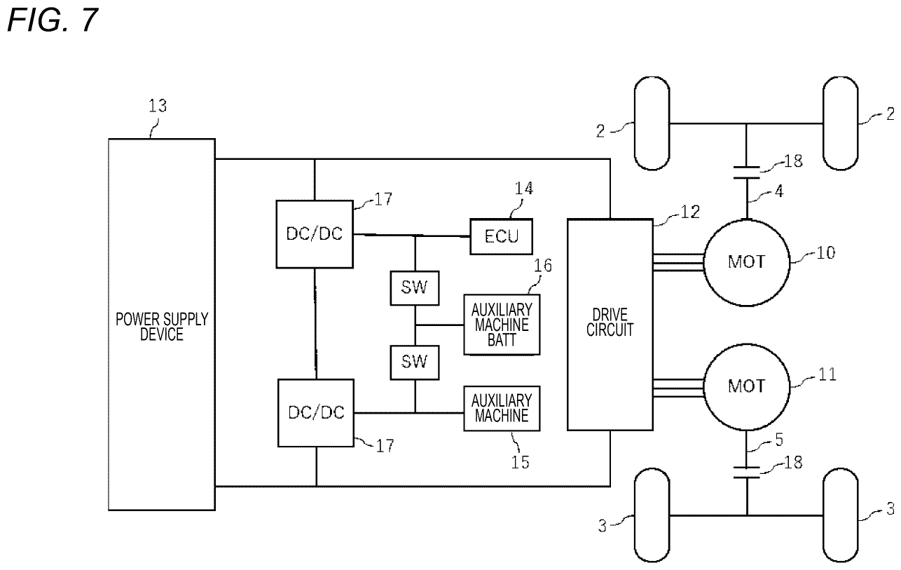

Preferably, as illustrated in FIG. 7, the power transmission path 4 between the first traveling motor 10 and the wheel 2 for receiving the power output from the first traveling motor 10 and the power transmission path 5 between the second traveling motor 11 and the wheel 3 for receiving the power output from the second traveling motor 11 are each provided with a connection/disconnection device 18. For example, to use the coil of the first traveling motor 10 for boosting, the first traveling motor 10 can be disconnected from the wheels 2 by the connection/disconnection device 18 of the power transmission path 4. Accordingly, the rotation of the rotor of the first traveling motor 10 can be stopped, thereby enabling a stable boosting operation. Similarly, to use the coil of the second traveling motor 11 for boosting, the second traveling motor 11 can be disconnected from the wheels 3 by the connection/disconnection device 18 of the power transmission path 5. Accordingly, the rotation of the rotor of the second traveling motor 11 can be stopped, thereby enabling a stable boosting operation.

Preferably, as described above, the power output from the first traveling motor 10 is transmitted to one wheel 2 among the front wheels and the rear wheels, the power output from the second traveling motor 11 is transmitted to the other wheel 3 among the front wheels and the rear wheels, and the drive wheels of the traveling motors are arranged on the front and rear sides of the electric vehicle 1. As a result, even if the voltage output from the power supply device 13 decreases to the second voltage, it is possible to continue traveling while minimizing the influence on the traveling of the electric vehicle 1. However, for example, the power of both the first traveling motor 10 and the second traveling motor 11 may be input to a common differential device, and one wheel among the front wheels or the rear wheels may be driven by the first traveling motor 10 and the second traveling motor 11.

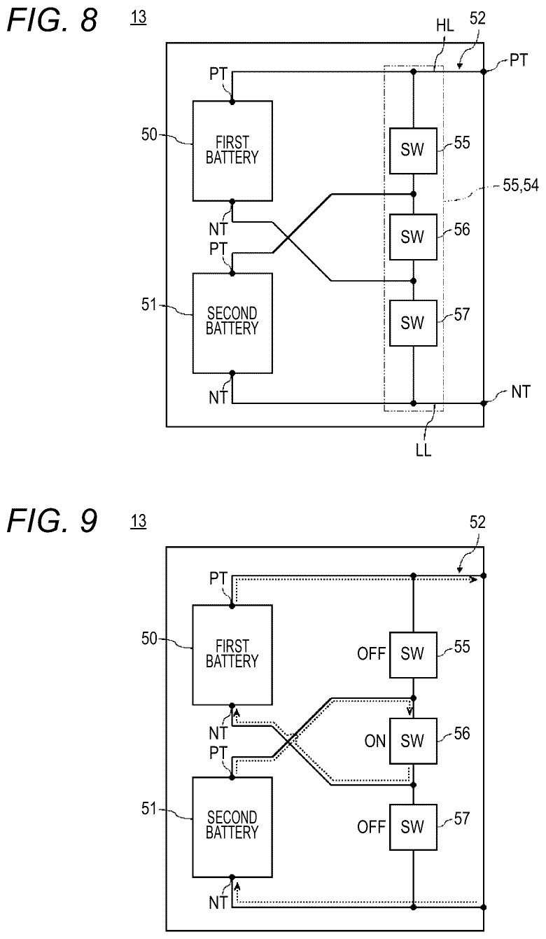

FIG. 8 illustrates the power supply device 13.

The power supply device 13 includes a first battery 50 and a second battery 51, which are main batteries, and an output circuit 52.

The first battery 50 includes a plurality of battery cells such as lithium-ion battery cells and nickel-hydrogen battery cells. A plurality of battery cells are connected in series and in parallel to ensure required voltage and capacity. The second battery 51 is also configured similarly to the first battery 50, and a plurality of battery cells are connected in series and in parallel to secure required voltage and capacity.

For example, the first battery 50 and the second battery 51 are configured to output a voltage of 400 volts in rated value if the output voltage required for the power supply device 13 is 800 volts in rated value. By connecting the first battery 50 and the second battery 51 to the output circuit 52 in series, the power supply device 13 can output a voltage of 800 volts as the first voltage. Alternatively, by connecting the first battery 50 and the second battery 51 to the output circuit 52 in parallel, or by connecting only one battery between the first battery 50 and the second battery 51 to the output circuit 52, the power supply device 13 can output a voltage of 400 volts as the second voltage.

The output voltage of the first battery 50 and the output voltage of the second battery 51 may be set to different voltages, as long as the output voltage required for the power supply device 13 when the first battery 50 and the second battery 51 are connected in series can be obtained. However, the output voltage of the first battery 50 and the output voltage of the second battery 51 are preferably set to the same voltage from the viewpoint of cost reduction by sharing the first battery 50 and the second battery 51, simplification of control of the drive circuit 12 and the charging circuit, and the like.

The output circuit 52 includes an output circuit switching unit 53. The output circuit switching unit 53 switches the configuration of the output circuit 52 between a first output configuration for outputting the first voltage and a second output configuration for outputting the second voltage. The output circuit switching unit 53 includes a switch circuit 54 bridged between a high-potential line HL and a low-potential line LL of the output circuit 52. The switch circuit 54 includes a first switch 55, a second switch 56, and a third switch 57. The first switch 55, the second switch 56, and the third switch 57 are connected in series in the order of the first switch 55, the second switch 56, and the third switch 57 from side closer to the high-potential line HL of the output circuit 52. The first switch 55, the second switch 56, and the third switch 57 are configured with, for example, semiconductor switching elements such as IGBT or MOSFET, or a mechanical switch such as relay, and are controlled to turn on/off by the ECU 14.

The positive electrode terminal PT of the first battery 50 is connected to the switch circuit 54 on the side closer to the high-potential line HL of the first switch 55. A negative electrode terminal NT of the first battery 50 is connected to the switch circuit 54 between the second switch 56 and the third switch 57. A positive electrode terminal PT of the second battery 51 is connected to the switch circuit 54 between the first switch 55 and the second switch 56. A negative electrode terminal NT of the second battery 51 is connected to the switch circuit 54 on the side closer to the low-potential line LL of the third switch 57.

FIG. 9 illustrates the output circuit 52 having the first output configuration.

In the first output configuration, among the first switch 55, the second switch 56, and the third switch 57, only the second switch 56 is turned on, and the first switch 55 and the third switch 57 are turned off. As indicated by a dashed arrow in FIG. 9, the negative electrode terminal NT of the first battery 50 and the positive electrode terminal PT of the second battery 51 are connected via the second switch 56 in the ON state, and the first battery 50 and the second battery 51 are connected to the output circuit 52 in series. Accordingly, the first voltage (for example, 800 volts) is output from the power supply device 13.

To output the first voltage from the power supply device 13, as described above, the drive circuit 12 is set to the first drive configuration, and the first drive circuit 20 and the second drive circuit 21 are connected to the power supply device 13 in parallel. The first drive circuit 20 and the second drive circuit 21 respectively generate three-phase AC currents based on the electric power of the first voltage supplied from the power supply device 13 to drive the first traveling motor 10 and the second traveling motor 11.

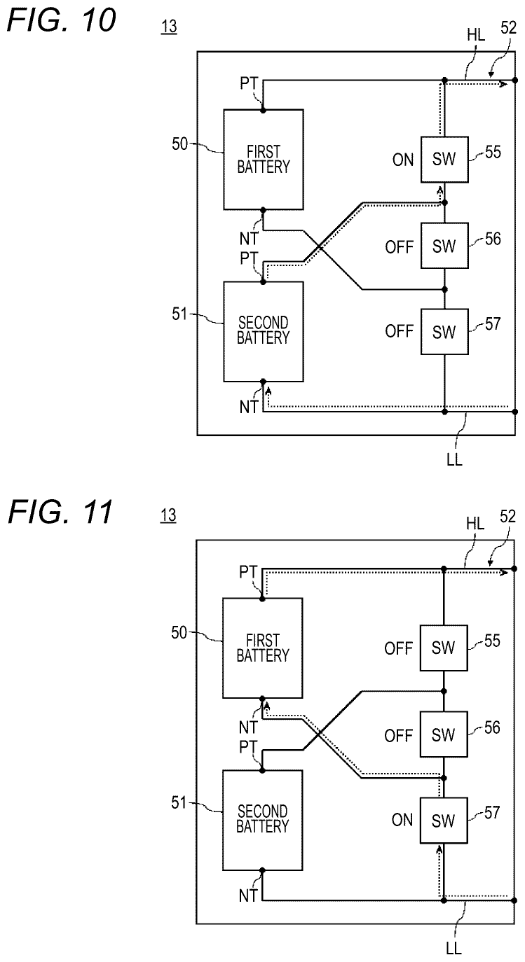

FIGS. 10 and 11 illustrate the output circuit 52 having the second output configuration.

If an abnormality occurs in one of the first battery 50 and the second battery 51, the ECU 14 controls the first switch 55, the second switch 56, and the third switch 57 to disconnect the battery in which the abnormality has occurred from the output circuit 52. Examples of the abnormality of the first battery 50 and the second battery 51 include an increase in battery temperature, an increase in battery internal pressure, and the like. Such abnormality is detected by sensors such as a temperature sensor and a pressure sensor and transmitted to the ECU 14.

FIG. 10 illustrates the second output configuration when an abnormality occurs in the first battery 50. Among the first switch 55, the second switch 56, and the third switch 57, only the first switch 55 is turned on, and the second switch 56 and the third switch 57 are turned off. The negative electrode terminal NT of the first battery 50 is disconnected from the low-potential line LL of the output circuit 52 by the third switch 57 in the OFF state, and the first battery 50 is disconnected from the output circuit 52.

On the other hand, as indicated by a dashed arrow in FIG. 10, the positive electrode terminal PT of the second battery 51 is connected to the high-potential line HL of the output circuit 52 via the first switch 55 in the ON state, and the negative electrode terminal NT of the second battery 51 is connected to the low-potential line LL of the output circuit 52. Therefore, the output voltage of the second battery 51 is output from the power supply device 13 as the second voltage (for example, 400 volts).

FIG. 11 illustrates the second output configuration when an abnormality occurs in the second battery 51. Among the first switch 55, the second switch 56, and the third switch 57, only the third switch 57 is turned on, and the first switch 55 and the second switch 56 are turned off. The positive electrode terminal PT of the second battery 51 is disconnected from the high-potential line HL of the output circuit 52 by the first switch 55 in the OFF state, and the second battery 51 is disconnected from the output circuit 52.

On the other hand, as indicated by a dashed arrow in FIG. 11, the positive electrode terminal PT of the first battery 50 is connected to the high-potential line HL of the output circuit 52, and the negative electrode terminal NT of the second battery 51 is connected to the low-potential line LL of the output circuit 52 via the third switch 57 in the ON state. Therefore, the output voltage of the first battery 50 is output from the power supply device 13 as the second voltage (for example, 400 volts).

To output the second voltage from the power supply device 13, the drive circuit 12 has the second drive configuration as described above. The direct supply of electric power from the power supply device 13 to the second drive circuit 21 is cut off, and the U-phase winding U, the V-phase winding V, and the W-phase winding W of the first traveling motor 10 and the switch circuits 31U, 31V, and 31W of the first drive circuit 20 form a booster circuit. The electric power of the second voltage is supplied from the power supply device 13 to the booster circuit, and the electric power boosted by the booster circuit is supplied to the second drive circuit 21. The second drive circuit 21 generates a three-phase AC current based on the boosted electric power to drive the second traveling motor 11. Alternatively, direct supply of electric power from the power supply device 13 to the first drive circuit 20 is cut off, and the U-phase winding U, the V-phase winding V, and the W-phase winding W of the second traveling motor 11 and the switch circuits 31U, 31V, and 31W of the second drive circuit 21 form a booster circuit. The electric power of the second voltage is supplied from the power supply device 13 to the booster circuit, and the electric power boosted by the booster circuit is supplied to the first drive circuit 20. The first drive circuit 20 generates a three-phase AC current based on the boosted electric power to drive the first traveling motor 10.

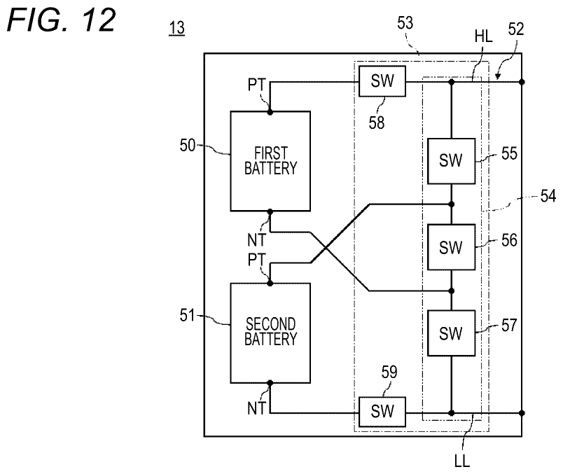

FIG. 12 illustrates a modification of the power supply device 13.

In the modification of the power supply device 13 illustrated in FIG. 12, the first switch 55, the second switch 56, and the third switch 57 of the switch circuit 54 are configured with semiconductor switching elements. A semiconductor switching element is generally more excellent in operation speed than a mechanical switch. The output circuit switching unit 53 further includes a first mechanical switch 58 and a second mechanical switch 59. A mechanical switch is generally more excellent in insulation in an OFF state than a semiconductor switching element.

The first mechanical switch 58 is provided between the positive electrode terminal PT of the first battery 50 and the switch circuit 54, and can disconnect the positive electrode terminal PT of the first battery 50 from the switch circuit 54. The second mechanical switch 59 is provided between the negative electrode terminal NT of the second battery 51 and the switch circuit 54, and can disconnect the negative electrode terminal NT of the second battery 51 from the switch circuit 54.

In the first output configuration, the first mechanical switch 58 and the second mechanical switch 59 are turned on in addition to the second switch 56, and the first switch 55 and the third switch 57 are turned off. The first battery 50 and the second battery 51 are connected to the output circuit 52 in series, and the first voltage (for example, 800 volts) is output from the power supply device 13.

In the second output configuration in which the first battery 50 is disconnected from the output circuit 52, the first switch 55 and the second mechanical switch 59 are turned on, and the second switch 56, the third switch 57, and the first mechanical switch 58 are turned off. The negative electrode terminal NT of the first battery 50 is disconnected from the low-potential line LL of the output circuit 52 by the third switch 57 in the OFF state, and the positive electrode terminal PT of the first battery 50 is also disconnected from the high-potential line HL of the output circuit 52 by the first mechanical switch 58 in the OFF state. Accordingly, the first battery 50 in which the abnormality has occurred can be more reliably disconnected from the output circuit 52.

In the second output configuration in which the second battery 51 is disconnected from the output circuit 52, the third switch 57 and the first mechanical switch 58 are turned on, and the first switch 55, the second switch 56, and the second mechanical switch 59 are turned off. The positive electrode terminal PT of the second battery 51 is disconnected from the high-potential line HL of the output circuit 52 by the first switch 55 in the OFF state, and the negative electrode terminal NT of the second battery 51 is also disconnected from the low-potential line LL of the output circuit 52 by the second mechanical switch 59 in the OFF state. Accordingly, the second battery 51 in which the abnormality has occurred can be more reliably disconnected from the output circuit 52.

Assuming that the output voltages of the first battery 50 and the second battery 51 are the same and both the first battery 50 and the second battery 51 are normal, the power supply device 13 in which the first switch 55, the second switch 56, and the third switch 57 are configured with semiconductor switching elements can also output an intermediate voltage (for example, 600 volts) between the output voltage obtained by connecting the first battery 50 and the second battery 51 in series (for example, 800 volts) and the output voltage of one of the first battery 50 and the second battery 51 (for example, 400 volts).

When the second switch 56, the first mechanical switch 58, and the second mechanical switch 59 are turned on and the first switch 55 and the third switch 57 are turned off, the first battery 50 and the second battery 51 are connected to the output circuit 52 in series. When the first mechanical switch 58 and the second mechanical switch 59 are maintained in the ON state, the first switch 55 and the third switch 57 are turned on, and the second switch 56 is turned off, the first battery 50 and the second battery 51 are connected to the output circuit 52 in parallel.

By controlling the first switch 55, the second switch 56, and the third switch 57 configured with semiconductor switching elements to turn on/off, the connection of the first battery 50 and the second battery 51 to the output circuit 52 is switched at high speed between series and parallel. This can obtain an intermediate voltage (for example, 600 volts) between the output voltage at the time of series connection (for example, 800 volts) and the output voltage at the time of parallel connection (for example, 400 volts). The intermediate voltage may be used as the second voltage of the power supply device 13.

In the present description, at least the following matters are described. Although corresponding constituent elements or the like in the above-described embodiment are illustrated in parentheses, the present disclosure is not limited thereto.
(1) An electric vehicle (electric vehicle 1) including:

a first traveling motor (first traveling motor 10) and a second traveling motor (second traveling motor 11);

a drive circuit (drive circuit 12) configured to drive the first traveling motor and the second traveling motor; and

a DC power supply device (power supply device 13) configured to supply electric power to the drive circuit, in which

the power supply device is configured to output a first voltage and a second voltage lower than the first voltage,

when supplied with the electric power of the first voltage, the drive circuit drives the first traveling motor and the second traveling motor with the electric power of the first voltage, and

when supplied with the electric power of the second voltage, the drive circuit boosts the electric power of the second voltage using a coil of the first traveling motor to drive the second traveling motor with the boosted electric power.
(2) The electric vehicle according to (1), in which

the coil of the first traveling motor includes multi-phase windings (U-phase winding U, V-phase winding V, W-phase winding W) configured to be excited to form a rotating magnetic field by a multi-phase AC current having different phases,

the drive circuit includes an inverter (inverter 30) configured to generate the multi-phase AC current from the electric power supplied from the power supply device by using a plurality of semiconductor switching elements (high-side switch 33H, low-side switch 33L), and

the multi-phase windings and the plurality of semiconductor switching elements form a booster circuit configured to boost the electric power of the second voltage.
(3) The electric vehicle according to (2), in which the drive circuit includes:
   a first drive circuit (first drive circuit 20) including the inverter and configured to drive the first traveling motor,
   a second drive circuit (second drive circuit 21) configured to drive the second traveling motor; and
   a drive circuit switching unit (drive circuit switching unit 40) configured to switch a configuration of the drive circuit between a first drive configuration and a second drive configuration,

in the first drive configuration, the drive circuit switching unit connects the first drive circuit and the second drive circuit to the power supply device in parallel, and

in the second drive configuration, the drive circuit switching unit disconnects a positive electrode terminal (positive electrode terminal PT) of the power supply device from positive-side input lines (positive-side input lines PL) of the first drive circuit and the second drive circuit, connects the positive-side input lines of the first drive circuit and the second drive circuit in series, and connects a neutral point (neutral point N) of the first traveling motor, where the multi-phase windings are combined, to the positive electrode terminal of the power supply device.
(4) The electric vehicle according to any one of (1) to (3), further including:

a connection and disconnection device (connection/disconnection device 18) configured to disconnect or connect a power transmission path between the first traveling motor and a drive wheel (wheel 2) that receives power output from the first traveling motor.
(5) The electric vehicle according to any one of (1) to (4), in which

the first traveling motor drives one (wheel 2) of a front wheel and a rear wheel of the electric vehicle, and

the second traveling motor drives other (wheel 3) of the front wheel and the rear wheel.
(6) The electric vehicle according to any one of (1) to (5), in which the power supply device includes:
   a first battery (first battery 50);
   a second battery (second battery 51); and
   an output circuit (output circuit 52),

the output circuit includes an output circuit switching unit (output circuit switching unit 53) configured to switch a configuration of the output circuit between a first output configuration and a second output configuration,

in the first output configuration, the output circuit switching unit connects the first battery and the second battery to the output circuit in series, so that the output circuit outputs the first voltage, and

in the second output configuration, the output circuit switching unit disconnects one of the first battery and the second battery from the output circuit, so that the output circuit outputs the second voltage.
(7) The electric vehicle according to (6), in which

the output circuit switching unit includes a switch circuit (switch circuit 54) bridged between a high-potential line (high-potential line HL) and a low-potential line (low-potential line LL) of the output circuit,

the switch circuit includes a first switch (first switch 55), a second switch (second switch 56), and a third switch (third switch 57) that are connected in series in order from a side closer to the high-potential line,

a positive electrode terminal (positive electrode terminal PT) of the first battery is connected to the switch circuit on a side of the first switch closer to the high-potential line,

a negative electrode terminal (negative electrode terminal NT) of the first battery is connected to the switch circuit between the second switch and the third switch,

a positive electrode terminal (positive electrode terminal PT) of the second battery is connected to the switch circuit between the first switch and the second switch, and

a negative electrode terminal (negative electrode terminal NT) of the second battery is connected to the switch circuit on a side of the third switch closer to the low-potential line.
(8) The electric vehicle according to (7), in which

the first switch, the second switch, and the third switch are semiconductor switching elements, and

the output circuit switching unit further includes:
a first mechanical switch (first mechanical switch 58) configured to disconnect the positive electrode terminal of the first battery from the switch circuit; and
a second mechanical switch (second mechanical switch 59) configured to disconnect the negative electrode terminal of the second battery from the switch circuit.

What is claimed is:

1. An electric vehicle comprising:
a first traveling motor and a second traveling motor;
a drive circuit configured to drive the first traveling motor and the second traveling motor; and
a DC power supply device configured to supply electric power to the drive circuit, wherein
the power supply device is configured to output a first voltage and a second voltage lower than the first voltage,
when supplied with the electric power of the first voltage, the drive circuit drives the first traveling motor and the second traveling motor with the electric power of the first voltage, and
when supplied with the electric power of the second voltage, the drive circuit boosts the electric power of the second voltage using a coil of the first traveling motor to drive the second traveling motor with the boosted electric power.

2. The electric vehicle according to claim 1, wherein
the coil of the first traveling motor includes multi-phase windings configured to be excited to form a rotating magnetic field by a multi-phase AC current having different phases,
the drive circuit includes an inverter configured to generate the multi-phase AC current from the electric power supplied from the power supply device by using a plurality of semiconductor switching elements, and
the multi-phase windings and the plurality of semiconductor switching elements form a booster circuit configured to boost the electric power of the second voltage.

3. The electric vehicle according to claim 2, wherein
the drive circuit includes:
a first drive circuit including the inverter and configured to drive the first traveling motor,
a second drive circuit configured to drive the second traveling motor; and
a drive circuit switching unit configured to switch a configuration of the drive circuit between a first drive configuration and a second drive configuration,
in the first drive configuration, the drive circuit switching unit connects the first drive circuit and the second drive circuit to the power supply device in parallel, and
in the second drive configuration, the drive circuit switching unit disconnects a positive electrode terminal of the power supply device from positive-side input lines of the first drive circuit and the second drive circuit, connects the positive-side input lines of the first drive circuit and the second drive circuit in series, and connects a neutral point of the first traveling motor, where the multi-phase windings are combined, to the positive electrode terminal of the power supply device.

4. The electric vehicle according to claim 1, further comprising:
a connection and disconnection device configured to disconnect or connect a power transmission path between the first traveling motor and a drive wheel that receives power output from the first traveling motor.

5. The electric vehicle according to claim 1, wherein
the first traveling motor drives one of a front wheel and a rear wheel of the electric vehicle, and
the second traveling motor drives other of the front wheel and the rear wheel.

6. The electric vehicle according to claim 1, wherein
the power supply device includes:
a first battery;
a second battery; and
an output circuit,
the output circuit includes an output circuit switching unit configured to switch a configuration of the output circuit between a first output configuration and a second output configuration,
in the first output configuration, the output circuit switching unit connects the first battery and the second battery to the output circuit in series, so that the output circuit outputs the first voltage, and
in the second output configuration, the output circuit switching unit disconnects one of the first battery and the second battery from the output circuit, so that the output circuit outputs the second voltage.

7. The electric vehicle according to claim 6, wherein
the output circuit switching unit includes a switch circuit bridged between a high-potential line and a low-potential line of the output circuit,
the switch circuit includes a first switch, a second switch, and a third switch that are connected in series in order from a side closer to the high-potential line,
a positive electrode terminal of the first battery is connected to the switch circuit on a side of the first switch closer to the high-potential line,
a negative electrode terminal of the first battery is connected to the switch circuit between the second switch and the third switch,
a positive electrode terminal of the second battery is connected to the switch circuit between the first switch and the second switch, and
a negative electrode terminal of the second battery is connected to the switch circuit on a side of the third switch closer to the low-potential line.

8. The electric vehicle according to claim 7, wherein
the first switch, the second switch, and the third switch are semiconductor switching elements, and
the output circuit switching unit further includes:
a first mechanical switch configured to disconnect the positive electrode terminal of the first battery from the switch circuit; and
a second mechanical switch configured to disconnect the negative electrode terminal of the second battery from the switch circuit.
